(19) United States
(12) Patent Application Publication
(10) Pub. No.: US 2006/0293169 A1
(43) Pub. Date: Dec. 28, 2006

(54) Molecular structures for gas sensing and devices and methods therewith

(75) Inventors: Duraiswamy Srinivasan, Bangalore (IN); Anis Zribi, Rexford, NY (US); Rashmi Raghavendra Rao, Bangalore (IN); Rajappan Vetrivel, Bangalore (IN)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 11/178,658

(22) Filed: Jul. 8, 2005

Related U.S. Application Data
(60) Provisional application No. 60/651,866, filed on Feb. 9, 2005.

(51) Int. Cl. B01J 29/04; H05F 3/00

(52) U.S. Cl. 502/60; 204/164

(57) ABSTRACT

A porous nanozeolite material having a first dimension less than about 1 micron and a second dimension less than about 100 microns. The nanozeolite material comprises pores having an average diameter less than about 50 nm. A method of making microporous nanozeolites is provided. The method comprises the steps of providing an aqueous solution comprising at least one nanozeolite precursor material or zeolite particles, and electrospinning the aqueous solution onto a substrate to form an electrospun material. The electrospun material comprises microporous nanozeolites. A method of making mesoporous nanozeolites is also provided. The method comprises the step of providing an aqueous solution comprising a nanozeolite precursor material and at least one structure directing agent, and electrospinning the aqueous solution onto a substrate to form an electrospun mesoporous nanozeolite material. A gas sensor device is provided. The device comprises nanozeolite sensing material.

### CROSS REFERENCE TO RELATED APPLICATIONS

This application claims the benefit of U.S. Provisional Application No. 60/651,866 filed on Feb. 09, 2005, which is incorporated herein in its entirety by reference.

### BACKGROUND OF THE INVENTION

The invention relates to molecular structures. Particularly, the invention relates to porous molecular structures.

Multiple gas sensing requires materials with desirable selectivity and sensitivity to adsorbent gas molecules and volatile vapors. Many gas sensors in the art have problems associated with interference, when more than one gas needs to be detected. Additionally, filters or traps are needed to block gas molecules, which are not being sensed.

Microporous and mesoporous zeolites, because of their highly porous framework along with tunable pore and channel dimensions, large active surface area, variable hydrophilic and hydroscopic nature, and electrostatic behavior, are potential materials for chemical and gas sensing applications. Additionally, the open and porous structure provided by zeolites offer better accessibility to gas molecules to diffuse in and out of the material, which could reduce considerably the response time of the sensor.

In miniaturized sensors, the area available for sensing is limited. Micro and nano scale materials with high ion active surface area, in contrast to continuous thin films, may compensate for this lack of space and enable the detection of trace amounts of gases.

The challenges associated with implementing zeolites in sensing applications are generally related to synthesizing zeolites with sub-micron or nano morphologies, and to coating sensor devices with such materials without detrimental effects to the devices. In bulk form, zeolites are typically made using hydrothermal synthetic processes. Such processes typically require high pressures, high temperatures, and long hydrolysis time, rendering them cumbersome, time consuming and not device friendly. Also, the structure of zeolites formed by these processes is often difficult to control and is dictated by the reactants used, by the synthesis conditions such as temperature, time, and pH, and in particular, by the structure-directing agent used. Alternative synthesis routes including solvent evaporation techniques, surfactant template schemes, inorganic-organic cooperative assembly processes and emulsion or sol-gel chemistries have also been explored in the art. It has also been suggested in the art that efficient deposition of silica fibers through the electrospinning process may require substrates with acid-filled anapore filters. But such methods are typically incompatible with conventional semiconductor device fabrication processes and cannot typically be used without deleterious effects on device integrity. Scalability of such processes for sensor production can also prove to be very challenging.

Therefore, there remains a need for nano scale zeolite materials, which can be used for sensing applications, and methods to make them efficiently. Further, there remains a need for a method to directly deposit these materials on device structures, such as semiconductor devices and MEMS devices, to enable nano scale zeolite material-based sensors.

### SUMMARY OF THE INVENTION

Embodiments of the invention meet these and other needs by providing porous nanozeolite type materials, method of making them, and nanozeolite based sensors.

Accordingly, one aspect of the invention is a porous nanozeolite material having a first dimension less than about 1 micron and a second dimension less than about 100 microns. The nanozeolite material comprises pores having an average diameter less than about 50 nm.

Another aspect of the invention is a method of making microporous nanozeolites. The method comprises the steps of providing an aqueous solution comprising at least one nanozeolite precursor material or zeolite particles, and electrospinning the aqueous solution onto a substrate to form an electrospun material. The electrospun material comprises microporous nanozeolites.

Another aspect of the invention is a method of making mesoporous nanozeolites. The method comprises the step of providing an aqueous solution comprising a nanozeolite precursor material and at least one structure directing agent, and electrospinning the aqueous solution onto a substrate to form an electrospun mesoporous nanozeolite material.

Another aspect of the invention is a sensor device. The sensor device comprises at least one material selected from the group consisting of microporous nanozeolites, mesoporous nanozeolites, and combinations thereof.

These and other aspects, advantages, and salient features of the present invention will become apparent from the following detailed description, the accompanying drawings, and the appended claims.

### BRIEF DESCRIPTION OF THE DRAWINGS

FIG. 1 is a schematic representation of an apparatus for electrospinning;

FIG. 2 is a flow chart representation of a method of making a microporous nanozeolite in one embodiment of the present invention;

FIG. 3 is a flow chart representation of a method of making a microporous nanozeolite in another embodiment of the present invention;

FIG. 4 is a flow chart representation of a method of making a mesoporous nanozeolite;

FIG. 5 is a flow chart representation of a method of making a mesoporous nanozeolite;

FIG. 6 is a SEM image of microporous nanozeolites in one embodiment of the present invention;

FIG. 7 is a SEM image of microporous nanozeolites in another embodiment of the present invention;

FIG. 8 is a SEM image of mesoporous nanozeolites in another embodiment of the present invention;

FIG. 9 is a SEM image of mesoporous nanozeolites in another embodiment of the present invention;

FIG. 10 is a SEM image of mesoporous nanozeolites in another embodiment of the present invention;

FIG. 11 is a SEM image of mesoporous porous nanozeolites in another embodiment of the present invention;

FIG. 12 is an EDS spectra of mesoporous nanozeolites in another embodiment of the present invention;

FIG. 13 is a picture of a quartz crystal microbalance with a nanozeolite deposit;

FIG. 14 is a SEM image of mesoporous nanozeolite on the quartz crystal microbalance.

### DETAILED DESCRIPTION OF PREFERRED EMBODIMENTS

Whenever particular features describe herein are said to comprise or consist of at least one element of a group and combinations thereof, it is understood that, except where otherwise so noted, the feature may comprise or consist of any of the elements of the group, either individually or in combination with any of the other elements of that group.

Referring to the drawings in general, it will be understood that the illustrations are for the purpose of describing a particular embodiment of the invention and are not intended to limit the invention thereto.

As defined herein, the term “nanozeolite” refers to a zeolite type material having a first dimension less than about 1 micron and a second dimension less than about 100 microns. As defined herein, the term “micropores” refers to pores having an average diameter of less than 2 nanometers (nm). As defined herein, the term “microporous” refers to materials with micropores. As defined herein, the term “mesopores” refers to pores having an average diameter of about 2 nm to about 50 nm. As defined herein, the term “mesoporous” refers to materials with micropores. As defined herein, the term “hybrid morphology” refers to mixed morphologies including but not limited to fibrous and particulate morphology. As defined herein, the term “high aspect ratio nanozeolites” refers to nanozeolites with a first dimension at least 100 times greater than a second dimension.

In one embodiment of the invention are porous nanozeolites having a first dimension less than about 1 micron and a second dimension less than about 100 microns, and wherein the nanozeolites comprise pores having an average diameter less than about 50 nm. In a further embodiment of the invention, the porous nanozeolites are microporous nanozeolites. In a still further embodiment of the invention, the porous nanozeolites are mesoporous nanozeolites.

Examples of anions, which may be found in nanozeolites, include but are not limited to silicate anions and aluminate anions. The porous nanozeolites have a fibrous morphology, or a particulate morphology, or hybrid morphology. In a further embodiment of the invention, the porous nanozeolites exhibit high sensitivity and high selectivity to adsorbent gas molecules and volatile vapors. The selectivity of a nanozeolite is typically determined by the diameter of the pores. Typically, molecules range in size from about 0.3 nm to about 50 nm and the nanozeolite pore diameters can be tailored to adsorb molecules within a desirable size range. The term “high selectivity” as used herein, refers to the ability of the nanozeolite to selectively adsorb only certain molecules. The term “high sensitivity” as used herein, refers to the ability of the nanozeolite to sense gas molecules present in trace amounts, typically in the parts per million range or less. Increasing the surface area of the porous nanozeolite material by making the nanozeolites with high aspect ratio enhances the sensitivity of porous nanozeolites. In a still further embodiment of the invention, the porous nanozeolites have surface areas greater than about 1000 square meters per gram.

In a further embodiment of the invention, the porous nanozeolites further comprise void spaces, which are designed by using the sol-gel chemistry of the zeolite precursor. In another embodiment, the nanozeolites are ordered porous nanozeolites. In a still further embodiment of the invention, the porous nanozeolites are short range crystalline in form, wherein the term “short range” refers to a range less than about 10 nanometers. In another embodiment, the porous nanozeolites can be designed at a molecular level by varying the silicon to aluminum ratio, and by varying the nature and level of exchanged cations. Examples of exchange ions include but are not limited to ions of alkali metals, alkaline earth metals, transition metals and rare earth metals. This enables the control of gas molecule traffic through the nanozeolite material. In a non-limiting example, porous nanozeolites of the invention exhibit selectivity in the adsorption and diffusion of different gases like CO₂, O₂, N₂, NOₓ, SO₂, and various hydrocarbons. The gases have different heat and kinetics of adsorption depending on the size, shape and polarity of the gas. In another embodiment, the adsorption level of the gases by the porous nanozeolites is tuned by synthesizing the nanozeolites with different pore architecture, pore diameter and channel dimensions.

In another embodiment of the invention, is a method for making microporous nanozeolites through electrospinning. In still another embodiment of the invention is a method for making mesoporous nanozeolites through electrospinning.

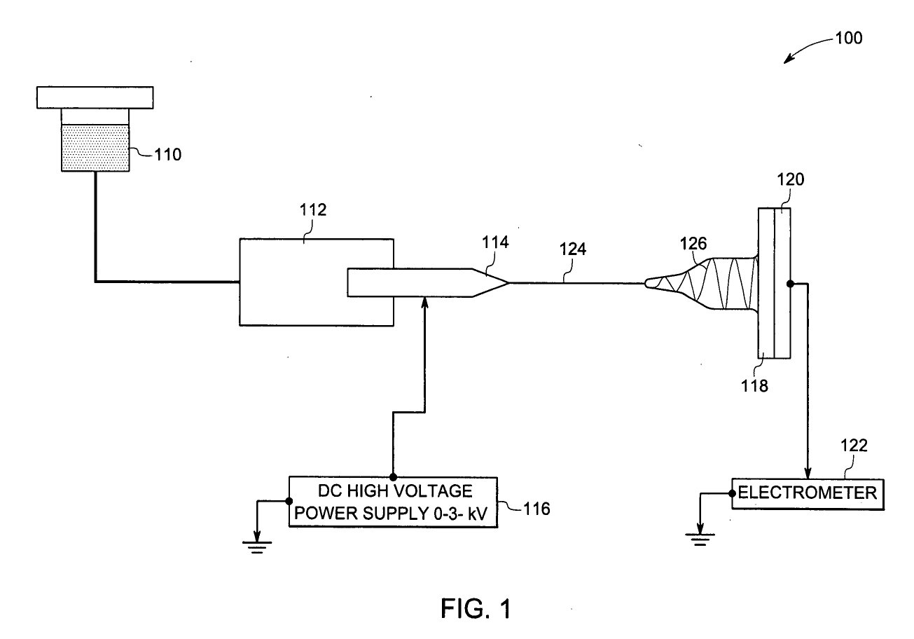

FIG. 1 shows an electrospinning apparatus 100. The electrospinning process typically involves the application of a strong electrostatic field between a capillary jet or needle tip 114, connected to a reservoir 110 with the sol-gel used to spin the nanozeolite material, and a substrate 120, which is typically grounded. When a high voltage is applied, typically in the range of about 5 to about 30 kilovolts, a spherical droplet of the sol-gel, which forms at the capillary tip, becomes conical in shape due to the counter electrostatic force acting against the surface tension of the liquid drop. If the voltage surpasses a threshold value, electrostatic forces overcome the surface tension, and a fine charged jet is ejected. The jet moves towards the grounded substrate, which may be any suitable substrate, such as, for example, a glass substrate or a MEMS device. Due to the large surface area of the jet, the solvent evaporates immediately after the jet is formed. The result is the deposition of material on the substrate with various morphologies, depending on electrospinning conditions.

In another embodiment of the invention, the mesoporous nanozeolites are electrospun from sol-gels with a pH in the range of about 1 to about 3. In another embodiment of the invention, the nanozeolites are electrospun using sol-gels with a viscosity in the range of about 3000 centipoise (cP) to about 30,000 cP.

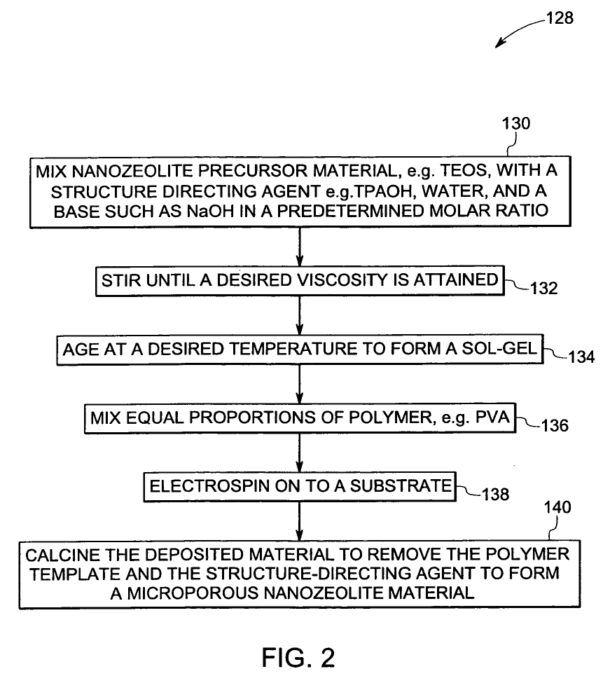

In one embodiment of the invention is a method for making microporous nanozeolites as illustrated in flow chart 128 seen in FIG. 2, comprising the steps of mixing the nanozeolite precursor material, for example tetraethyl ortho silicate (TEOS), with a structure directing agent such as tetrapropylammonium hydroxide (TPAOH), water, and a base such sodium hydroxide (NaOH) 130, in a predetermined molar ratio, stirring until a desired viscosity is attained 132, aging at a desired temperature and pressure to form a sol-gel 134, mixing with equal proportions of polymer, for example PVA, 136, electrospinning on to a substrate 138, and calcining the deposited material to remove the polymer template and the structure-directing agent to form a microporous nanozeolite material 140.

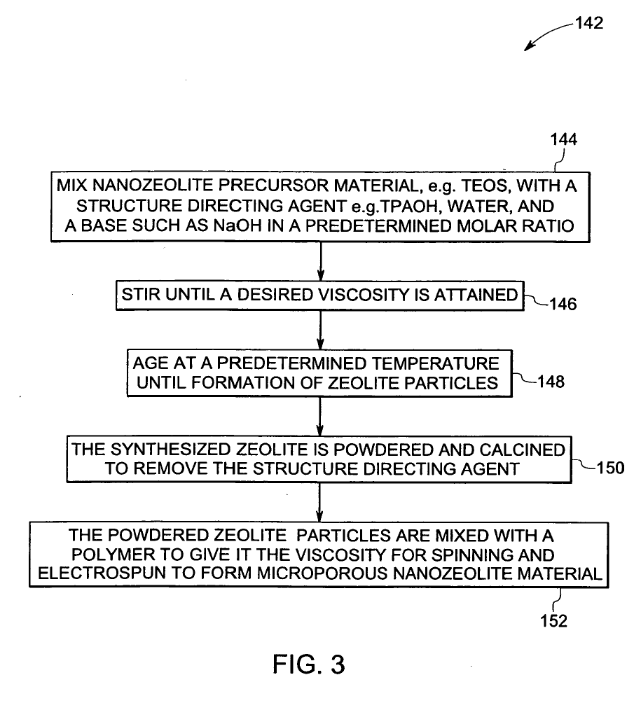

In a further embodiment of the invention is a method for making microporous nanozeolites as illustrated in the flow chart in FIG. 3. The method comprises the steps of mixing nanozeolite precursor material, for example TEOS, with a structure directing agent such as TPAOH, water, and a base such as NaOH in a predetermined molar ratio 144, stirring until a desired viscosity is reached 146, aging at a desired temperature and pressure to form zeolite particles 148, powdering the synthesized zeolite particles and calcining to remove the structure directing agent 150, and mixing with a polymer to give it the viscosity for spinning and electrospinning to form a microporous nanozeolite material 152.

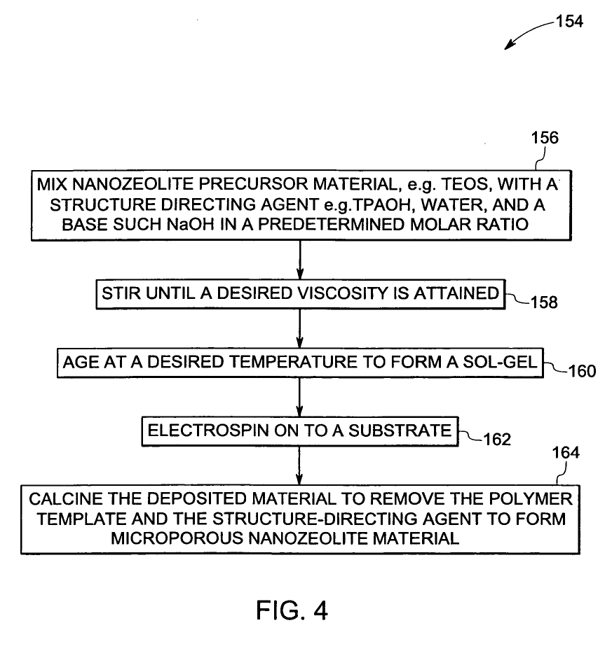

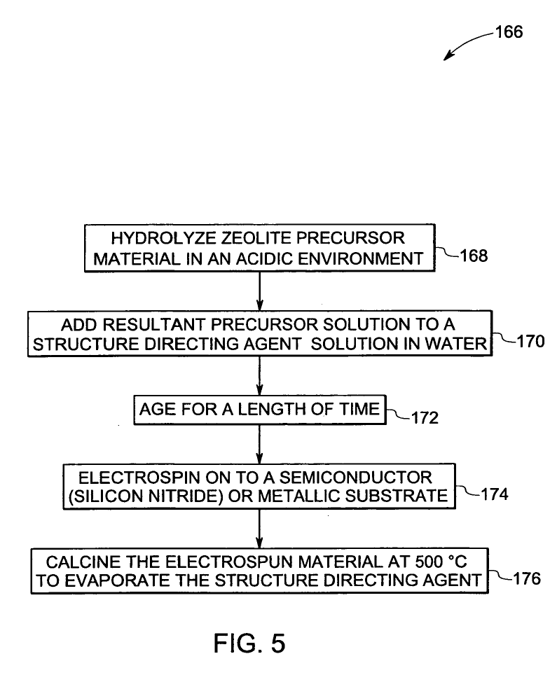

In still further an embodiment of the invention is a method for making microporous nanozeolites as illustrated in the flow chart in FIG. 4, comprising the steps of mixing the nanozeolite precursor material, for example TEOS, with a structure directing agent such as TPAOH, water, and a base such NaOH 156, in a predetermined molar ratio, stirring until a desired viscosity is attained 158, aging at a desired temperature to form a sol-gel 160, electrospinning the gel on to a substrate 162, and calcining the deposited material to remove the polymer template and the structure-directing agent to form a microporous nanozeolite material 164.

In another embodiment of the invention is a method for making mesoporous nanozeolites as illustrated in the flow chart in FIG. 4, comprising the steps of hydrolyzing zeolite precursor material in an acidic environment 168, adding resultant precursor solution to a structure directing agent solution in water 170, aging for a length of time 172, electrospinning on to a semiconductor (silicon nitride) or metallic substrate 174, and calcining the electrospun material to evaporate the structure directing agent 176.

In another embodiment of the present invention, the pore sizes and hence the selectivity of the nanozeolites is controlled by the structure directing agent. Examples of structure directing agents which can be used in embodiments of the present invention include, but are not limited to, trimethylammonium bromide (CTAB), cetyltrimethylammonium chloride, pluranic-123 C, poly(ethylene oxides), Brij® 76, and poly(ethylene oxide)ₓ-poly(propylene oxide)_{y}-poly(ethylene oxide)ₓ, tetraethylammonium fluoride, quaternary ammonium ions, hexametyleneimine, tetrapropylammonium hydroxide, and combinations thereof.

Examples of zeolite precursor materials include but are not limited to tetra ethyl orthosilicate, tetra methyl orthosilicate, tetra butyl orthosilicate, SiO₂ particles, sodium aluminate, and combinations thereof. Examples of zeolite materials include, but are not limited to, MCM-41, MCM-48, MCM-50, SBA-15, SBA-11, SBA-1, SBA-2, SBA-3, silicalite-1, zeolite-A, ZSM-5, ZSM-11, ZSM-23, MFI, H ferrierite, and combinations thereof. Examples of polymer materials include, but are not limited to, polyvinyl alcohol, polyethyleneimine, polycarbonate, polyethylineoxide, polyetherimide, polyamide, poly(acrylonitrile), and combinations thereof.

In one embodiment of the invention, the method to deposit nanozeolites includes the step of selecting the shape of the needle or capillary jet to provide a desired uniformity of the nanozeolite coating on the substrate. In another embodiment of the present invention, the spinning time is varied to deposit nanozeolite layers of varied thickness. In a non-limiting example, the spinning time was varied between a few seconds to 10 minutes.

In a further embodiment of the invention, the method of making nanozeolites includes the step of electrospinning using a plurality of capillary jets. In a still further embodiment, a pump system or pressure source is used to control the flow rate of the sol-gel through the capillary jet. In another embodiment, the method of making nanozeolites includes the step of using a shadow mask to selectively deposit porous nanozeolites on a substrate surface. Non-limiting examples of substrates include, quartz, semi-conducting materials such as silicon nitride, and metallic substrates.

The physical, mechanical, and electrical properties of the sol-gel used to electrospin the porous nanozeolites affect the characteristics of the nanozeolites. The hydrodynamic properties of the fluid depend on a combination of physical and mechanical properties, (e.g., surface tension and viscosity) and electrical properties (e.g., charge density and polarizability of the fluid).

In one embodiment of the invention, increasing the applied voltage and the spinning distance desirably favors the formation of fibrous morphology over particulate morphology. Below a certain critical voltage, micro-dripping, electro-spraying mode is favored and the liquid jet is unable to form and sustain the Taylor cone at the tip of the needle, resulting in particle spraying. For sol-gels, the spinning distance is desirably increased to reach the instability region of the jet where it splits into multiple jets to give nanozeolites with fibrous morphology. At lower spinning distances, hybrid morphologies combining fibrous and particulate nanozeolites are produced. In a still further embodiment, at sol-gel viscosities greater than about 4000 cP, predominantly nanozeolites with fibrous morphology are formed. In another embodiment of the present invention, at sol-gel viscosities lower than about 4000 cP, predominantly nanozeolites with hybrid morphology are formed.

Another embodiment of the invention is a sensor device, comprising a sensing material, wherein the sensing material comprises at least one material selected from the group consisting of microporous nanozeolites, mesoporous nanozeolites, and combinations thereof. In a further embodiment, the device comprises a gas-sensing device. In a non-limiting example, the gas-sensing device is a micro electromechanical system (MEMS) gas-sensing device. In a further example, the device is a CO₂ sensing device. Non-limiting examples of the gas sensing device operate by adsorption of the gas molecules, resulting in a measurable change in mass or change in heat content or change in electrical conductivity or change in resonance wavelength or combinations thereof.

The following examples serve to illustrate the features and advantages of embodiments of the invention and are not intended to limit the invention thereto.

A schematic diagram of the electrospinning apparatus 100 is shown in FIG. 1. It consists of a reservoir 110, where the sol-gel solution was loaded, connected to a Harvard syringe pump 112 having a straight or bent needle 114, typically a 23 gauge metallic needle. The needle tip was connected to a high voltage power supply 116 (Gamma ESP30-5W) with a DC voltage output in the range of 0 to 30 kV. A standard semiconductor substrate 118, such as silicon nitride was held in front of the needle and connected to the power supply ground through a ground plate 120 connected to an electrometer 122. In the case of a non-conducting device, a conducting coating, a plate or a foil was used to provide electrical contact. A spinning voltage of about 10 kV to about 30 kV was used. The spinning distance was typically from about 10 cm to about 30 cm. Solution parameters such as pH were typically from about 1 to 5, and viscosity was from about 6000 cp to about 15000 cp. For selective deposition, a shadow mask was placed between the syringe needle and the substrate to cover specific areas. On application of a high voltage, for example 20 kV, to the solution, a jet 124 of the solution was formed. The solvent evaporates and a jet so formed typically divides into multiple jets, which in turn divide and subdivide to typically form a network typically of fibrous material 126, which are attracted to the ground plate 120 attached to the substrate 118, and are collected on the substrate 118.

A JEOL 6335F scanning electron microscope with an Oxford EDAX detector was used to evaluate the morphology of the electrospun materials and their chemical make up. Secondary electron micrographs were used to investigate the morphology of the formed materials, while x-ray spectra were used to estimate the silica content in the formed phases.

### EXAMPLE 1

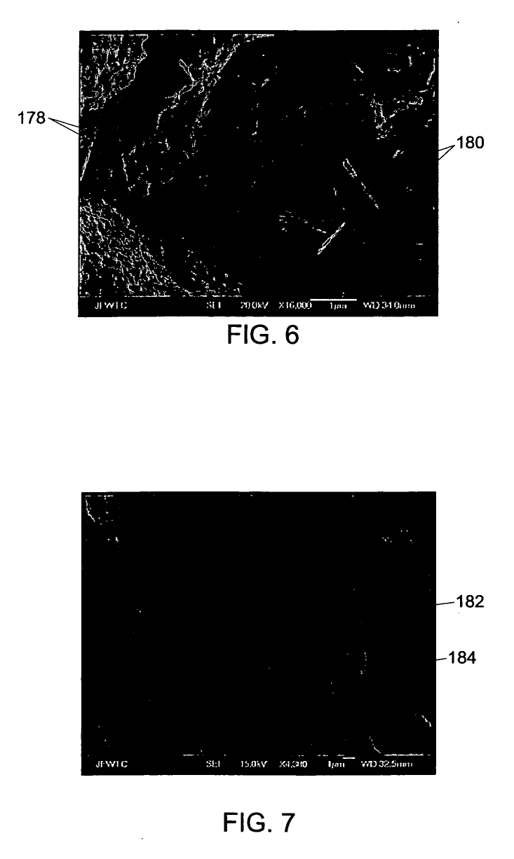

TEOS was mixed with a structure directing agent TPAOH, water, and NaOH, in a molar ratio of about 0.25:0.09:4.8:1.0. The mixture was subsequently stirred for about 4 to about 5 hours and aged at 70° C. for about 3 to about 6 hours resulting in a sol-gel. The resulting sol-gel was mixed in equal proportions with polyvinyl alcohol (PVA) and was used to electrospin the sol-gel and polymer solution directly on to a semiconductor substrate. The spinning distance was 15 cm and the applied voltage was 15 kV. After electrospun material deposited on the substrate is calcined at 500° C. for about 4 hours, to remove the polymer template and structure-directing agent to give a microporous nanozeolite material. FIG. 6 shows the scanning electron microscope (SEM) image of the microporous zeolites showing hybrid morphology 178. PVA enables the formation of needle-like structures 180.

### EXAMPLE 2

TEOS was mixed with a structure directing agent TPAOH, water and NaOH in the molar ratio of about 0.25:0.09:4.8:1.0. The mixture was subsequently stirred for about 4 to 5 hrs and aged at 70° C. for 48 to 72 hours to form silicalite-1 zeolites. The synthesized silicalite-1 is powdered and calcined at 500° C. for about 4 hours to remove the structure directing agent. The powdered silicalite-1 particles are mixed with polyvinyl alcohol (PVA) to give it the required viscosity for spinning and electrospun to form microporous silicalite-1 nanozeolite. FIG.7 is a SEM micrograph showing microporous silicalite-1 with PVA after electrospinning. Silicalite-1 particles 184 of varied diameters can be seen embedded in polymeric fibers 182. The zeolite particle size can be controlled in the nanometer range to help enhance the active surface area of the sensing material and to help increase gas adsorption capability.

### EXAMPLE 3

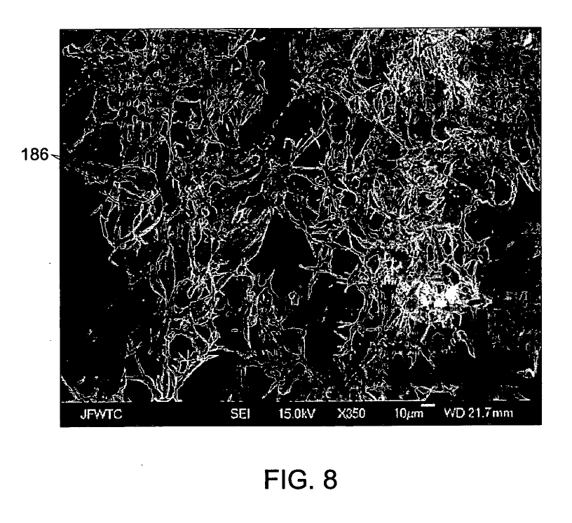

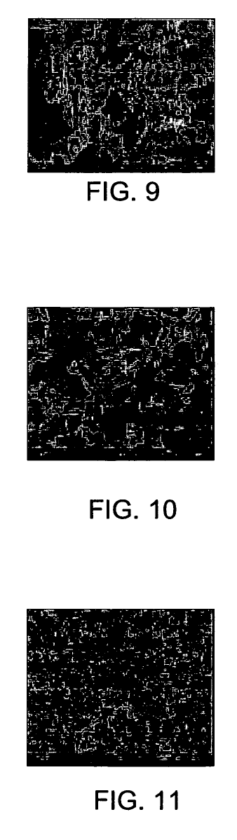

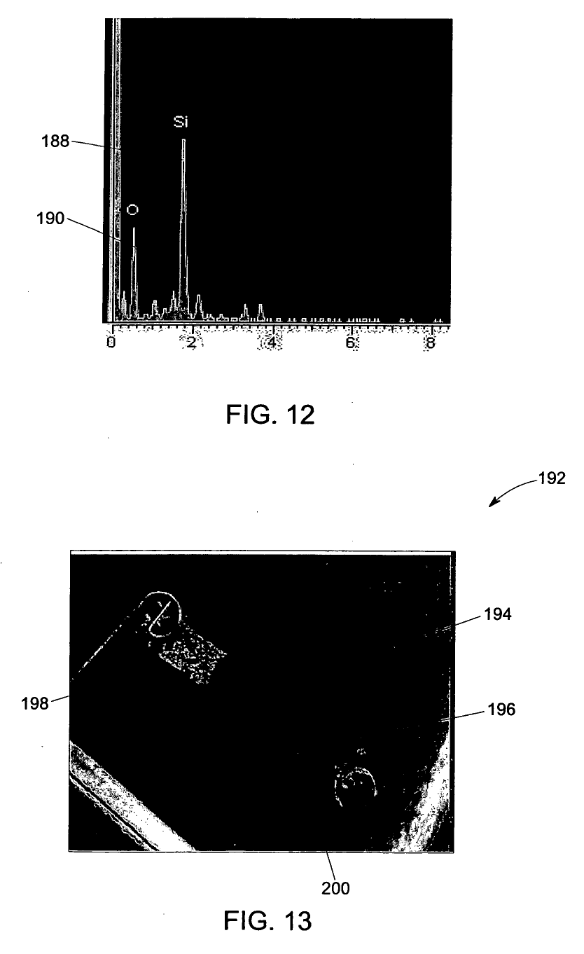

A sol-gel aqueous solution consisting of TEOS or tetra methyl orthosilicate (TMOS) with structure directing agent cetyltrimethylammonium bromide (CTAB) was used to synthesize mesoporous nanozeolite. The molar ratio of TEOS:Water:CTAB was fixed at about 4:8:1. TEOS was first hydrolyzed in an acidic environment (pH=1.85) and the resultant precursor solution is added drop-wise to the structure directing agent solution (CTAB) and aged for about 36 to about 48 hrs. A Brooke Field Viscometer was used to measure the sol-gel solution viscosity as a function of time and pH. The solution was electrospun and calcined at a spinning distance of about 7 cm to about 15 cm. The electrospun material was calcined at 500° C. for about 2 hour to evaporate the structure-directing agent to give mesoporous MCM-41 type nanozeolites with diameters in the micron to nanometer range with high aspect ratios. FIGS. 8, 9, 10 and 11 are SEM micrographs of MCM-41 type mesoporous nanozeolite materials. The energy dispersive spectroscopy (EDS) spectrum as shown in FIG. 12, reveals the composition is SiO₂ with appropriate silicon 188 to oxygen 190 ratio.

### EXAMPLE 4

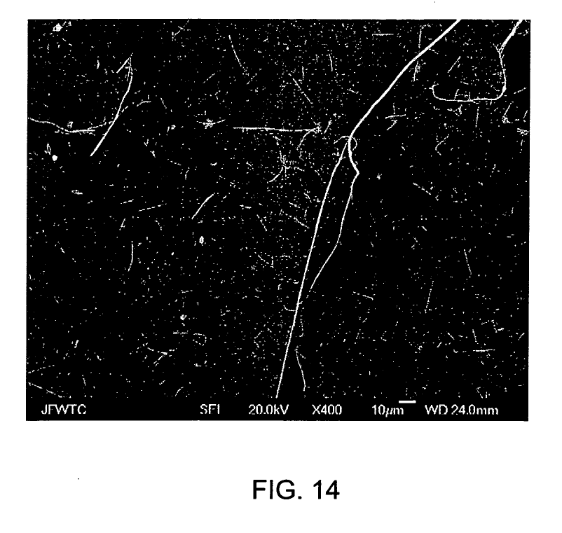

In one embodiment of the present invention, as shown in FIG. 13, is a MEMS based gas sensor comprising a quartz crystal microbalance (QCM) 192. The heart of the QCM typically comprises a piezoelectric quartz crystal 194 sandwiched between a pair of electrodes 196 and 198. Mesoporous or microporous nanozeolites 200 are deposited on one or both electrodes. When the electrodes are connected to an oscillator and an AC voltage is applied across the electrodes, the quartz crystal oscillates at its resonance frequency due to the piezoelectric effect. When the nanozeolites adsorb certain gas molecules, e.g. CO₂, the resonant frequency changes in proportion to the mass of the adsorbed gas molecules. This change in resonance frequency is measurable and can be used to identify the gas molecules adsorbed. FIG. 14 shows a SEM micrograph of a mesoporous nanozeolite material deposited on a QCM electrode.

The previously described embodiments of the present invention have many advantages, including electrospinning micro and mesoporous nanozeolites without condensation of the electrospun material in an acidic environment and without porous filters. The sensor device embodiments of the invention show high sensitivity and selectivity.

While typical embodiments have been set forth for the purpose of illustration, the foregoing description should not be deemed to be a limitation on the scope of the invention. Accordingly, various modifications, adaptations, and alternatives may occur to one skilled in the art without departing from the spirit and scope of the invention.

What is claimed is:

1. An electrospun porous nanozeolite, comprising anions, wherein the nanozeolite has a first dimension less than about 1 micron and a second dimension less than about 100 microns, and wherein the nanozeolite comprises pores having an average diameter less than about 50 nm.

2. The porous nanozeolite of claim 1, wherein the nanozeolite comprises one or more anions from the group consisting of silicate anions and aluminate anions.

3. The porous nanozeolite of claim 1, wherein the nanozeolite comprises one of fiber morphology, particulate morphology, and hybrid morphology.

4. The microporous nanozeolite of claim 1, wherein the nanozeolite comprises pores having an average diameter of less than 2 nm.

5. The mesoporous nanozeolite of claim 1, wherein the nanozeolite comprises pores having an average diameter from about 2 nm to about 50 nm.

6. A method of forming a microporous nanozeolite with pores having an average diameter less than 2 nm, comprising:
a) providing an aqueous solution comprising at least one nanozeolite precursor material or zeolite particles; and
b) electrospinning the aqueous solution onto a substrate to form an electrospun material, wherein the electrospun material comprises microporous nanozeolites.

7. The method of claim 6, wherein the aqueous solution comprises at least one polymer.

8. The method of claim 7, further comprising calcining the electrospun material to remove the polymer.

9. The method of claim 6, wherein the polymer is at least one selected from the group consisting of polyvinyl alcohol polyethyleneimine, polycarbonate, polyethylineoxide, polyetherimide, polyamide, poly(acrylonitrile), and combinations thereof.

10. The method of claim 6, wherein the nanozeolite precursor material is at least one selected from the group consisting of TEOS, TMOS, TBOS, SiO₂ particles, sodium aluminate, and combinations thereof.

11. The method of claim 6, wherein the zeolite particles is at least one selected from the group consisting of MCM-41, MCM-48, MCM-50, SBA-15, SBA-11, SBA-1, SBA-2, SBA-3, silicalite-1, zeolite-A, ZSM-5, ZSM-11, ZSM-23, MFI, H ferrierite, and combinations thereof.

12. The method of claim 6, wherein the aqueous solution comprises at least one structure-directing agent.

13. The method of claim 12, wherein the structure directing agent is at least one selected from the group consisting of cetyltrimethylammonium bromide, cetyltrimethylammonium chloride, pluranic-123 C, poly(ethylene oxides), Brij® 76, and poly(ethylene oxide)ₓ-poly(propylene oxide)_{y}-poly(ethylene oxide)ₓ, tetraethylammonium fluoride, quaternary ammonium ions, hexametyleneimine, tetrapropylammonium hydroxide, and combinations thereof.

14. The method of claim 6, wherein the step of electrospinning comprises spinning from a plurality of capillary jets.

15. The method of claim 6, wherein the substrate is at a ground potential or is disposed on a ground plate.

16. The method of claim 6, wherein the substrate is at least one selected from the group consisting of silicon nitride, quartz, silicon, metal, device structure element, and combinations thereof.

17. The method of claim 6, further comprising selectively depositing the microporous nanozeolite on the substrate.

18. The method of claim 17, wherein said selectively depositing comprises using a shadow mask.

19. A method of forming a mesoporous nanozeolite with mesopores having an average diameter from about 2 nm to about 50 nm on a device substrate, comprising:
a) providing an aqueous solution comprising a nanozeolite precursor material and at least one structure directing agent; and
b) electrospinning the aqueous solution onto a device substrate to form an electrospun mesoporous nanozeolite material.

20. The method of claim 19, wherein the structure directing agent is at least one selected from the group consisting of cetyltrimethylammonium bromide, cetyltrimethylammonium chloride, pluranic-123 C, poly(ethylene oxides), Brij® 76, and poly(ethylene oxide)ₓ,-poly(propylene oxide)_{y}-poly(ethylene oxide)ₓ, tetraethylammonium fluoride, quaternary ammonium ions, hexamethyleneimine, tetrapropylammonium hydroxide, and combinations thereof.

21. A sensor device comprising a sensing material, wherein the sensing material comprises at least one material selected from the group consisting of microporous nanozeolites, mesoporous nanozeolites, and combinations thereof.

22. The device of claim 21, wherein the device is a gas-sensing device.

23. The device of claim 22, wherein the gas-sensing device is a MEMS gas-sensing device.

24. The device of claim 22, wherein the gas-sensing device is a CO₂ sensing device.

25. The device of claim 22, wherein the gas-sensing device is at least one selected from the group consisting of devices operable by sensing mass variation, heat variation, electrical conductivity variation, resonance wavelength variation, and combinations thereof.
